(19) United States
(12) Patent Application Publication
(10) Pub. No.: US 2015/0215414 A1
(43) Pub. Date: Jul. 30, 2015

(54) OUT OF BAND ELECTRONIC SIGNALING

(71) Applicant: Alexander V. Kariman, Rockville, MD (US)

(72) Inventor: Alexander V Kariman, Rockville, MD (US)

(73) Assignee: SAFE FRONTIER LLC, McLean, VA (US)

(21) Appl. No.: 14/164,306

(22) Filed: Jan. 27, 2014

(51) Int. Cl. H04L 29/08

(52) U.S. Cl. CPC H04L 67/26

(57) ABSTRACT

The present disclosure relates to an electronic signaling architecture of an out-of-band stack located on an electronic device, providing an improved method, apparatus, and system for facilitating communication between an out-of-band stack of an electronic device and local and/or remote facilities. According to one aspect of the present disclosure, the out-of-band stack may send and receive data using push and pull communication technologies.

### FIELD OF THE INVENTION

The present invention generally relates to electronic devices and methods for communicating information and performing actions using a subsystem largely independent from a primary device system. Electronic devices equipped with such subsystem can be operated when the main system is off or malfunctions. Such devices include but not limited to electronic devices of all form-factors: personal computers, servers, mobile computing devices, including phones, tablets, digital assistants, scanners, and the like. The disclosure herein also relates to embedded systems (including integrated systems and real-time systems). Such embedded systems include, but not limited to: industrial equipment, micro and macro embedded systems, intelligent meters, controllers, network-ware, embedded automotive, marine, and aerospace systems, POS and retail equipment, ATM and banking, digital signage, entertainment systems, gaming systems, surveillance, infotainment, medical systems, critical embedded systems, household and office-use embedded systems, recreational and educational embedded systems, embedded systems equipped with a radio module, including cellular radio, embedded systems used in automation, energy, mining, special and general purpose embed systems, and the like.

### BACKGROUND

An embodiment of the present disclosure generally relates to communication of network resources and components and, more specifically, to an architecture by which an out-of-band stack can exchange information with an in-band stack of the same electronic device, as well as a network resource.

Out-of-band management systems, such as manageability engine (ME), active management technology (AMT), and the like, should be able to efficiently communicate with other resources and systems, including network resources. Various mechanisms exist for monitoring and managing network devices in-and-out-of band. Device management software typically has two methods by which a remote console can perform management of a network device. The first method includes an “in-band” stack where an Operating System (OS)-based service retrieves data from the OS, basic input/output system (BIOS), or baseboard management controller (BMC), and reporting such data to remote software typically via TCP/IP. The second method is referred to as “out-of-band”, where a remote application communicates directly with a BMC of the electronic device. It may utilize a serial connection over a serial port or LAN via UDP socket connection. Another example is the active management, where a microcontroller may have active management capabilities, such as Intel® Active Management Technology (AMT). It may also have an out-of-band communication capability. Utilizing the out-of-band capabilities, a communication channel may be established, for example, AMT may use Intel® Application Port Forwarding protocol (APF) to establish a secure tunnel between the AMT and a network resource.

Out-of-band management was first considered in the era of desktops and servers being the predominant computing instruments that were mainly managed in local networks. Taking into consideration the emergence of different new electronic devices of various form-factors, and having new use-models with new requirements, a different communication technology and architecture is required to provide more efficient out-of-band information exchange. Among the new requirements is significantly reduced utilization of network bandwidth, reduced electrical power consumption, very large number of communicating devices, small and very small form-factors, as well as the Internet oriented use-model. Out-of-band management is also assuming more simplistic utilization with many devices being relatively uncomplicated. However, out-of-band management is still remaining an essential resource for advanced manageability and security of network-enabled electronic devices, specifically embedded devices that may operate autonomously and may not be readily accessible by technicians. Nevertheless, lightweight out-of-band communication is also required for traditional computing, such as laptops, e.g., Intel® vPro, to be able to communicate with Internet-based monitoring stations without significantly adding to electrical power consumption and network use for simple out-of-band signaling.

A variety of out-of-band systems of different designs are known. Most of them, however, primarily address electronic device theft, geo-location, and server management. For example, as described in the U.S. Pat. No. 8,528,041 B1 (Publication date Sep. 3, 2013), a computer-implemented method of network management featuring network clients for out-of-band network security management. Another invention, the U.S. Pat. No. 7,853,682 B2 (Publication date Dec. 14, 2010) in essence describes a system and method for out-of-band network management, wherein one or more different management interfaces are converted into a common format management data. Another disclosure, the U.S. application Ser. No. 13/817,932 (Publication date Jun. 13, 2013) in essence describes an electronic component, baseboard management controller, and a device hardware agent. The device hardware agent monitors operation of the electronic component and provides updates to the electronic component without utilizing a software agent. Another invention, the U.S. Pat. No. 8,566,847 B2 (Publication date Oct. 22, 2013) in essence describes some approaches for out-of-band host management via a management controller. Another invention, the U.S. Pat. No. 8,260,741 B2 (Publication date Sep. 4, 2012) in essence describes a pluggable, extensible, lightweight framework that provides an out-of-band server management connection to interact with plurality of operating system resident agents. Another invention, the U.S. Pat. No. 8,295,157 B1 (Publication date Oct. 23, 2012) in essence encompasses an out-of-band management stack that is located on a managed node, receiving a management command from an out-of-band management application located on an administrative system. It allows remote management of a node by an administrative system via out-of-band protocols, while in-band communication with the administrative system is not available. Unlike the aforementioned invention, the current disclosure does not require an in-band management agent and out-of-band management channel availability is not contingent upon the non-availability of the in-band stack.

The disclosed invention is aiming to incorporate lightweight communication technologies, enabling more efficient network utilization, new capabilities, and more efficient power management, all incorporated into the design of an out-of-band operating stack.

### DESCRIPTION OF THE INVENTION

The following description and the referrals to the accompanying drawings show, by way of illustration, specific details and aspects of this disclosure in which the invention may be practiced. The word “exemplary” is used herein to mean “serving as an example, instance, or illustration”. Any aspect of this disclosure described herein is not necessarily to be construed as preferred or advantageous over other aspects of this disclosure or designs unless expressly stated. The term “push technology” may also mean a sender initiating data transfer rather than a recipient. “Publish/Subscribe” essentially may also include a client that subscribes to various queues (information channels) provided by brokering software. The term “pull technology” essentially may also include network communication where the initial request for data originates from a client, and then is responded to by a server. The term “operating system” may be understood as an independent program of instructions and shall furthermore include software that operates in the operating system or coupled with the independent program of instructions. A “circuit” (or “circuitry”) may be understood as any kind of logic implementing entity, which may be hardware (in some exemplary embodiment, including silicon), software, firmware, or any combination thereof. Thus, a “circuit” may be a hard-wired logic circuit or a programmable logic circuit such as a programmable processor, e.g. a microprocessor. A “processor” may also be understood as any number of processor cores, controller, or microcontroller, or plurality and combination thereof. A “circuit” may also be software being implemented or executed by a processor, e.g. any kind of computer program. Any other kind of implementation of the respective functions described herein may also be understood as a “circuit” or “circuitry”. The terms “coupling” or “connection” are intended to include a direct coupling or direct connection, as well as an indirect “coupling” or indirect “connection” respectively, as well as logical or physical coupling. A “network” may be understood as any physical and logical network, including Internet network, local network, wireless or wired network, or system bus, etc. A “website” may be understood as a data storage medium, a server, a gateway, a proxy, a database, a peered electronic device, a computing device, a device communicating over wired or wireless network, a device having electronic circuitry, plurality and combination thereof. A coupled or connected “device” may be understood as physical and virtual device having circuitry. An “operating mode” may be understood as an operating state e.g., a reduced functionality state to conserve electrical power or to reduce heat emission, etc. A “communication tunnel” may be understood to include communications performed using a plurality of network protocols encapsulated via an encapsulation protocol, such as VPN, APF, SSL, TLS, etc., therefore, acting as a wrapper for a channel that the network protocol being tunneled uses to communicate. A “service processor” or “out-of-band processor” may include at least one processing unit that controls system critical tasks, such as receiving system management information, sending messages to monitor system performance and security, logging system management information, executing critical tasks as a reserve system, etc. Such out-of-band processor may comprise of circuitry, for example, a controller, a microcontroller, and may be located on an electronic device main board, silicon, integrated into a subsystem or a coupled system, such as a network or a video card. An “out-of-band stack” may be understood as an out-of-band operating system or an out-of-band processor, or both. A “message” and “notification” may be used interchangeably and may be understood to mean “data”. An “execution engine” may be understood to include an electronic circuit essentially having some or all capabilities of a baseboard management controller or an active management controller, such as AMT. Manageability engine (ME) and active management technology (AMT) may be referenced herein interchangeably and essentially mean the same thing.

In the following description, numerous specific details such as logic implementations, means to specify operands, resource implementations, types and interrelationships of system components, and logic choices may be set forth in order to provide a more thorough understanding of the present disclosure. It will be appreciated, however, by one skilled in the art that embodiments of the disclosure may be practiced without such specific details. In other instances, control structures, circuits, and full software instruction sequences may have not been shown in order not to obscure the disclosure.

The present disclosure provides an improved method, apparatus, and system for facilitating communication between an out-of-band stack of an electronic device and local and/or remote facilities. According to one aspect of the present disclosure, the out-of-band stack may send and receive data using push and pull communication technologies. Where in some exemplary embodiment, such communication can be accomplished using publish/subscribe communication model and multi-casting/broadcasting addressing, for instance, using MQTT, STOMP, AMQP, and other protocols. In another exemplary embodiment, such communication may be accomplished using long polling (for example, but not limited to Comet). In some exemplary embodiment, this lightweight out-of-band communication channel may be used to exchange data with plurality of remote websites, for example transmitting messages and receiving messages from other websites and electronic devices. In some exemplary embodiment, such communication can be centralized, using intermediary websites serving as message brokers, or decentralized, using pear to pear communication; where in other exemplary embodiment such message broker may be located in an in-band stack of the electronic device. In other exemplary embodiment, such broker can be located in an out-of-band stack to retransmit messages from other electronic devices. In some exemplary embodiment, this lesser overhead communication method can be employed to send commands over the Internet to plurality of electronic devices without a need for establishing a network communication tunnel. An example of such tunnel is as essentially implemented in the Intel® AMT Client Initiated Remote Access (CIRA) that leverages Intel® Application Port Forwarding protocol to create a tunnel with a proxy gateway (for example, Intel® Manageability Presence Service) to exchange information with a remote application. In another example, some out-of-band communication systems are using Virtual Private Network (VPN) that also requires establishing a communication tunnel prior to exchanging information. In one exemplary embodiment of this discourse, such communication tunnel may be created as a result of receiving a notification from a website, as described in some exemplary embodiment of this disclosure. Many other embodiments and variations are possible.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

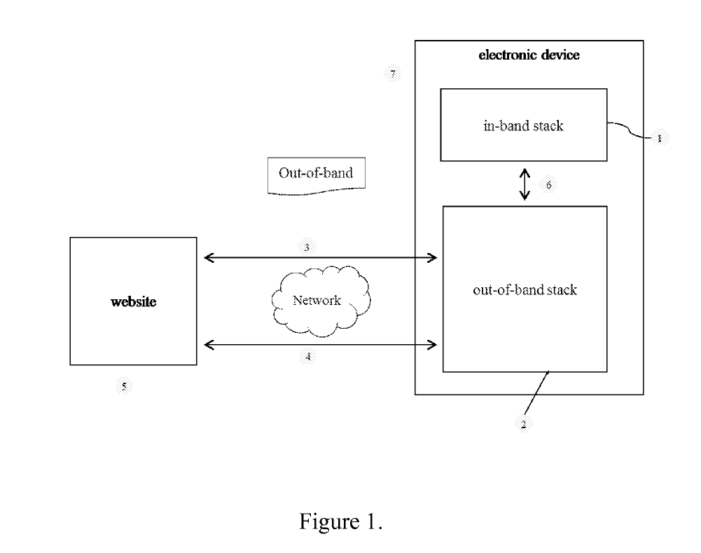

FIG. 1 illustrates an exemplary embodiment of the disclosure where at least two discrete out-of-band communication channels, whether concurrent or consecutive, are established between a website 5 and an electronic device 7 having out-of-band 2 and in-band 1 stacks. In some exemplary embodiment, a communication channel 3 may be employing a publish/subscribe model, and another channel may be an end-to-end communication tunnel 4. In some exemplary embodiment, the out-of-band stack 2 and the in-band stack 1 may communicate 6 using push or pull technologies, as described in this disclosure. Such communication may also be concurrent or consecutive or unrelated to the communication with a website 5.

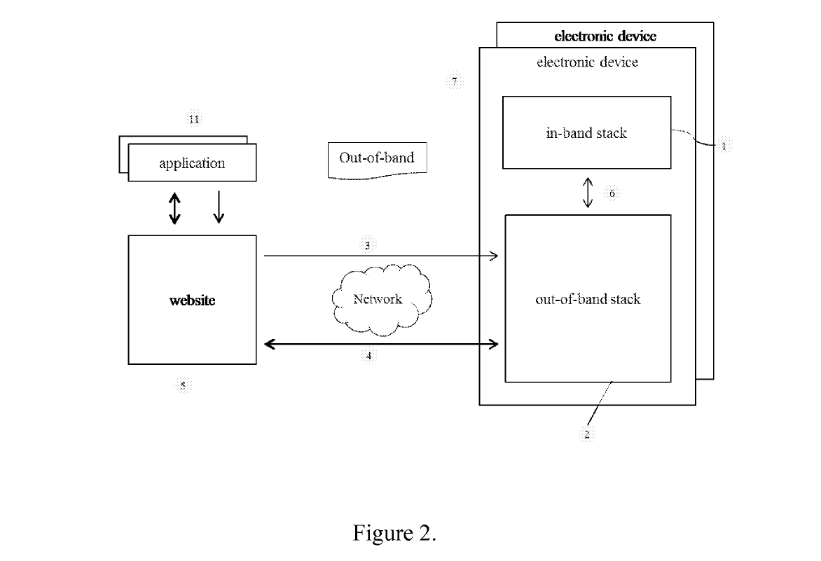

FIG. 2 illustrates an exemplary embodiment of the disclosure, where there is a notification (or an instruction to send a notification) sent from an application 11 via a website 5 (or to a website 5), and subsequently a notification 3 is sent to plurality of electronic devices 7 that have out-of-band stack 2, and received by such out-of-band stack 2, instructing the out-of-band stack 2 to establish a communication tunnel 4 with a website 5, where using such tunnel 4, the application 11 may connect to the electronic device 7. In another exemplary embodiment, such notification may instruct the out-of-band stack 2 to communicate 6 with the in-band stack 1.

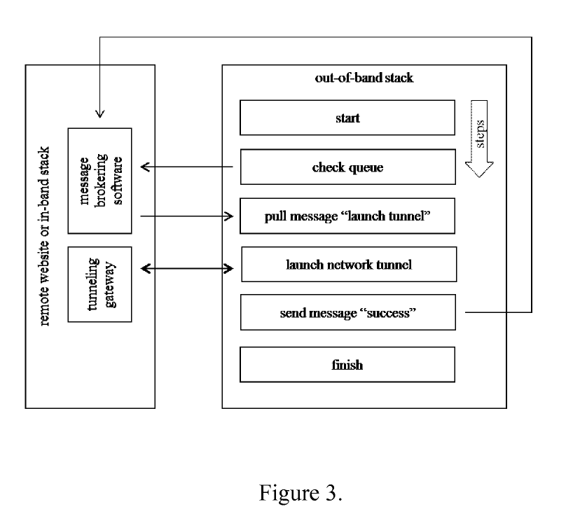

FIG. 3 illustrates an exemplary embodiment of the method where a message is pulled by the out-of-band stack located on the electronic device, instructing the out-of-band stack to establish a communication tunnel, and such tunnel is established after processing such message, and another message is then sent notifying that the communication tunnel is established.

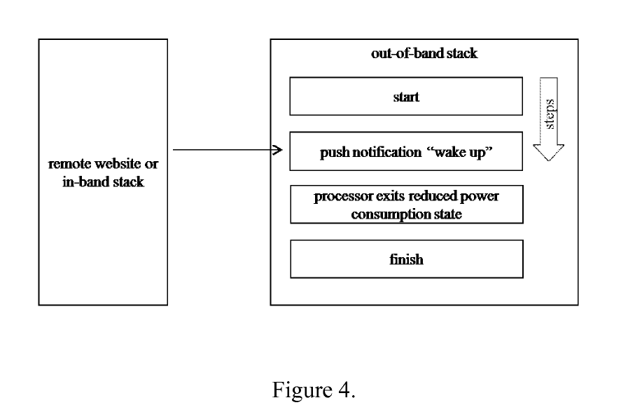

FIG. 4 illustrates an exemplary embodiment of the method where a notification is pushed by a website. In another exemplary embodiment, such notification may be pushed by an in-band stack to an out-of-band stack located on the electronic device. The notification may be instructing the out-of-band stack to change a processor operating mode, and such procedure is executed after the notification is processed.

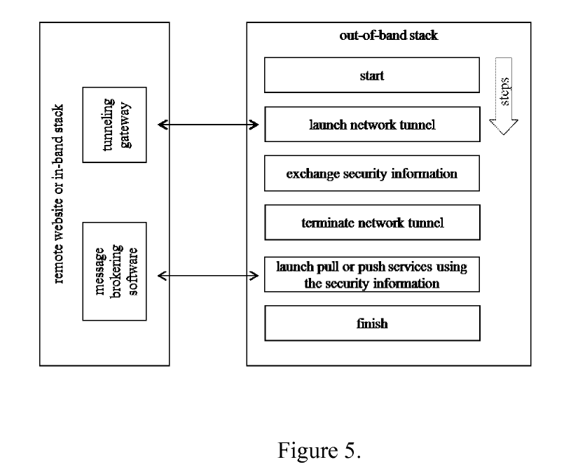

FIG. 5 illustrates an exemplary embodiment of the method of providing or updating security credentials for communicating using secure publish/subscribe or pear to pear communication channel, where the credentials are provided using prior established secure communication tunnel. In some exemplary embodiment, secure communication may be accomplished using login/password and symmetric encryption keys; or as, for example, but not limited to, described in the following disclosure U.S. application Ser. No. 11/466,670 (Publication date: 22 Mar. 2007). In some exemplary embodiment, the security credentials for publish/subscribe or pear to pear communication can be updated out-of-band, from time to time, using a secure communication tunnel. Therefore, lesser overhead protocols that do not natively accommodate more sophisticated secure networking can be employed for out-of-band and in-band noncritical transactions.

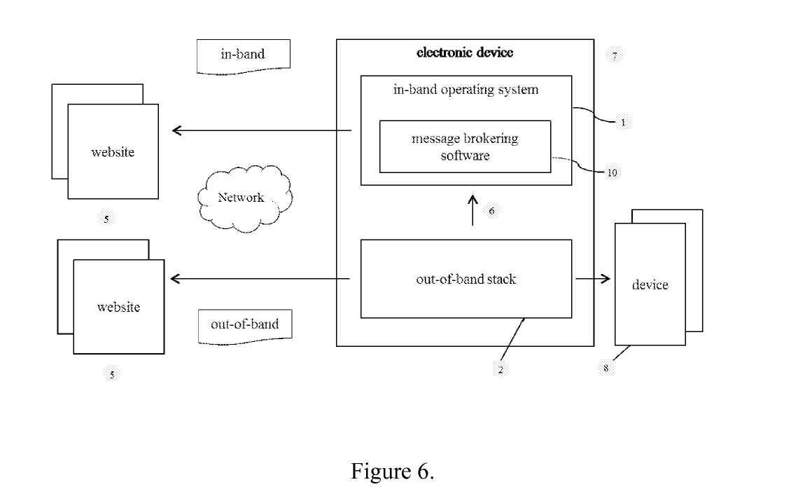

FIG. 6 illustrates an exemplary embodiment of the disclosure, where the out-of-band stack 2 located on an electronic device 7 broadcasts a message to plurality of websites 5 over an out-of-band network, where among others, in some exemplary embodiment, there is an in-band stack 1 receiving a message 6, as well as plurality of communicatively coupled devices 8. In another exemplary embodiment, the in-band stack 1 proxy a message, using message brokering software 10, to plurality of websites 5 via an in-band channel. In another exemplary embodiment, such electronic device 7 multicasts such message to a specific recipient group.

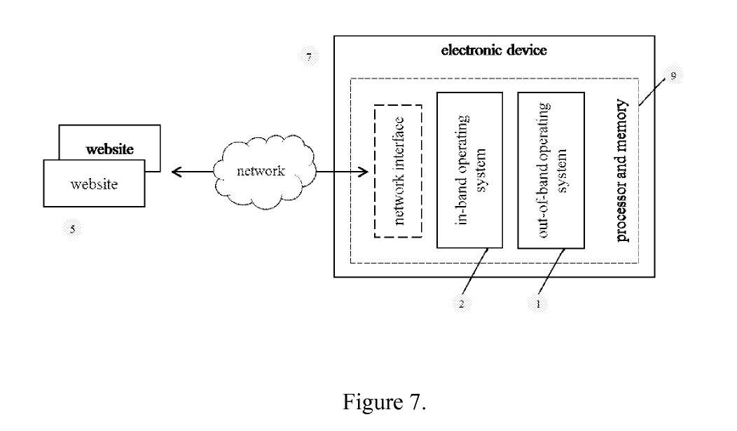

FIG. 7 illustrates an exemplary embodiment of the disclosure, where the out-of-band stack 2 and the in-band stack 1 are executed by the same processor 9, whether consecutively or concurrently, for example, each by its own core.

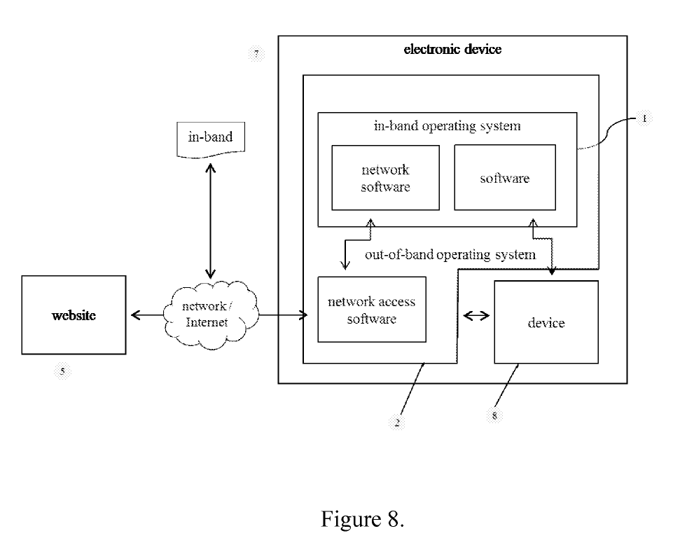

FIG. 8 illustrates an exemplary embodiment of the disclosure, where the in-band operating system 1 may be executed in the virtual environment of the out-of-band operating system 2.

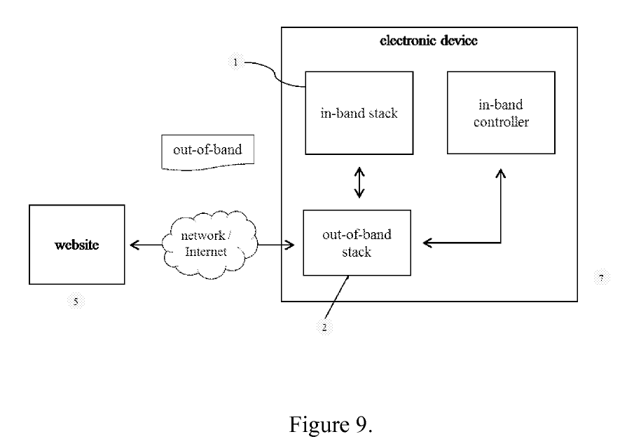

FIG. 9 illustrates an exemplary embodiment of the disclosure, where the out-of-band stack 2 is communicatively coupled with the in-band stack 1 and the in-band controller. In one exemplary embodiment, the out-of-band stack 2 can be used to remotely communicate with the in-band controller using interfaces of the in-band controller to perform certain procedures on the in-band controller. In another exemplary embodiment, an execution engine may be coupled with the out-of-band stack to facilitating communication with the electronic device systems and buses.

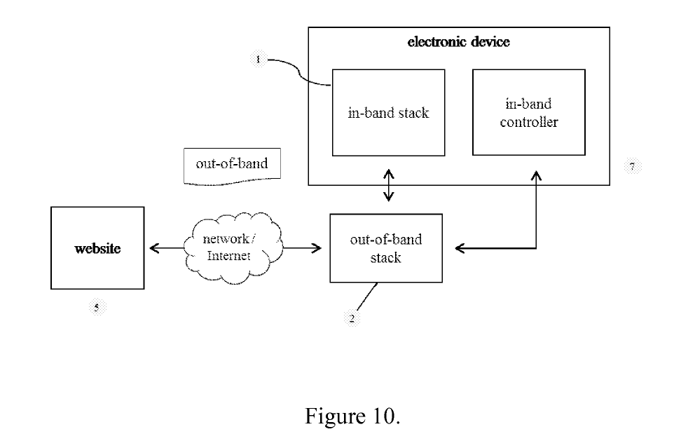

FIG. 10 illustrates an exemplary embodiment similar to FIG. 9 but where the out-of-band stack 2 is physically separate from the in-band stack 1 media; and in another exemplary embodiment, it can be a separate article communicatively coupled with the electronic device 7. In another exemplary embodiment, the out-of-band stack 2 may be located on an electronic circuit coupled with the electronic device 7; and in another exemplary embodiment, the out-of-band stack 2 may be located on a video card, network card, radio module, or any other system coupled with the electronic device 7.

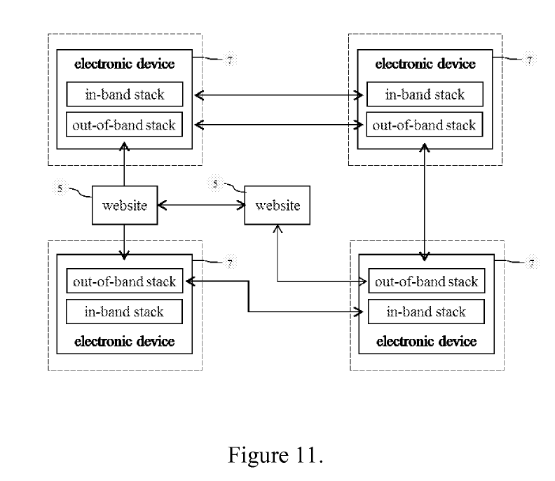

FIG. 11 illustrates an exemplary embodiment of the disclosure that exemplifies, among other subject matter, several network communicational arrangements between electronic devices 7 and websites 5 via in-band and out-of-band channels.

One exemplary embodiment includes a method and an apparatus that allows reducing power consumption of an out-of-band system, being able to operate an out-of-band microcontroller in a reduced power state. A remote application may send a push message to the out-of-band stack of an electronic device, as described in some embodiment of this disclosure. Upon receiving a push notification that includes a certain command and discarding other notifications, such microcontroller may be invoked to a fully operational state. In another exemplary embodiment, another notification may be sent to the out-of-band stack to perform a certain procedure, where an application running in the out-of-band stack can execute a certain code instruction, as indicated in the notification. After the procedure is performed such microcontroller may again enter into a reduced power state. Nevertheless, in some exemplary embodiment, any notification may invoke an out-of-band controller; and in another exemplary embodiment, such notification may contain multiple instructions, for example, but not limited to containing an executable script. In another exemplary embodiment, such notification may originate from an in-band stack, using a coupling interface between the in-band stack and the out-of-band stack. For example, certain in-band software may utilize programming interfaces of the out-of-band stack and use an internal and/or external communication interface of the circuitry to exchange data with the out-of-band stack. In another exemplary embodiment, such in-band software may receive a notification form the out-of-band stack; and in another exemplary embodiment, such software may leverage the out-of-band stack and channel to transmit data to a coupled out-of-band network.

One exemplary embodiment includes method and apparatus that allows reducing network bandwidth consumption of an out-of-band stack, enabling out-of-band signaling using lesser overhead communication technologies. An out-of-band system may provide persistent notifications regarding different aspects of an electronic device lifecycle management. With large number of devices, potentially large number of notifications, and plurality of subscribers, using end-to-end communication is inefficient. In some exemplary embodiment, out-of-band stack may monitor plurality of events on an electronic device, and some events may need to be communicated to a number of monitoring stations. This task could be well achieved using lightweight publish/subscribe protocols, optimized for large number of smaller messages, multiple recipients, with messages having varying degree of delivery QoS, depending on the criticality of a message. In one exemplary embodiment, such system may comprise of multiple applications that subscribe to such notifications, a scalable server that acts as a message broker, and plurality of electronic devices connecting to such server. Message brokering server has plurality of queues by subject matter, where plurality of electronic devices post their notifications, being subscribed to the respective queues. The remote applications are also subscribed to the respective queues and therefore able to receive such notifications. One electronic device may be subscribed to plurality of queues and one application may be also subscribed to plurality of queues. Therefore, notifications can be delivered nearly instantly “one to one”, “one to many”, and “many to many” with reduced networking overhead.

Another exemplary embodiment illustrates a similar system as above, but where the message broker is located on the electronic device. Therefore, in some exemplary embodiment, the electronic device may be a source of notifications, and at the same time retransmitting notifications from other electronic devices, as well as managing queues and subscriptions. Such message broker may be located in an in-band stack and/or an out-of-band stack. In some exemplary embodiment, there is an electronic device, such as a data gateway, located in the industrial settings, and having out-of-band capabilities. The out-of-band stack is configured to provide notifications to a number of remote monitoring stations, where such notifications may originate from the gateway itself and from electronic devices connected to such gateway. In one exemplary embodiment, such gateway may be equipped with message brokering software located in the out-of-band stack. The gateway is connected to an external network; and plurality of electronic devices connected to such gateway but not to the external network. The message brokering software may have message-channeling queues that such devices are subscribed to in order to post and receive messages. Plurality of remote applications may be communicatively coupled with such gateway and being able to subscribe to such queues to post and receive messages. Therefore, such applications may send messages to plurality of electronic devices connected to such gateway and receive notifications from such devices and the gateway itself.

Another exemplary embodiment illustrates a similar system as above, but where the message broker is also located in the in-band stack of the electronic device. Therefore, in some exemplary embodiment, the electronic device may be transmitting out-of-band notifications in the in-band channel, and transmitting in-band notifications to the out-of-band stack, and in some exemplary embodiment, subsequently such notifications may be transmitted in the out-of-band channel. In one exemplary embodiment, message brokering software is located in the in-band stack and the out-of-band stack is subscribed to at least one queue of such message brokering software. Upon a certain event, the out-of-band stack may access such queue and post or receive a notification to/from at least one application, whether such application is local or remote, communicatively coupled with the in-band stack. In another exemplary embodiment, message brokering software may be located in both, the out-of-band stack and the in-band stack, and be communicatively coupled to be able to channel messages.

One exemplary embodiment of the disclosure provides out-of-band communication between plurality of electronic devices having out-of-band capabilities. One exemplary embodiment includes exchanging information out-of-band with plurality of websites. Another exemplary embodiment includes an electronic device equipped with a location detection system, such as a GPS receiver. Such GPS receiver is communicatively coupled, among other, to an out-of-band stack of the electronic device. Such GPS is able to determine geo-location of the coupled electronic device at predetermined time intervals. An out-of-band stack located on the electronic device is able to receive such location data and form a notification, and able of posting such notification to an appropriate queue of a remote message brokering server. Plurality of applications may be accessing such queue and retrieving such data. In another exemplary embodiment, an out-of-band stack may be communicatively coupled to an environmental sensor. The out-of-band stack may be probing such sensor at preset time intervals or upon a certain event, obtaining data from such sensor. Out-of-band stack may then form a notification and post it to appropriate queue of message brokering software located in the out-of-band stack. Plurality of external and internal applications may then be accessing such data. In another exemplary embodiment, an out-of-band stack is communicatively coupled with at least one intelligent actuator. Such actuator is capable of performing a certain mechanical function, such as opening and closing a container lid. The out-of-band stack is also subscribed to a queue on a remote message brokering server, where such out-of-band stack may obtain a message containing a command to operate such actuator. In another exemplary embodiment, such out-of-band stack may also post a notification to such queue indicating that the operation was performed. In another exemplary embodiment, such message brokering software may be located in the out-of-band stack, where each such actuator may have a dedicated queue where local and remote applications may post and receive messages. In another exemplary embodiment, software operating in the out-of-band stack may access such queues, processing the messages and sending appropriate signals to operate such actuators; and in another exemplary embodiment, such software may be receiving information from sensors then forming and posting messages containing the information to the dedicated queues of such sensors. Multiple sensors and/or actuators may also be grouped by such software and virtually subscribed to one or more queues. In another exemplary embodiment, such actuator may be operated by an electronic relay or another circuitry. In another exemplary embodiment, any circuitry may be coupled with an out-of-band stack containing message brokering software to post and receive messages. In another exemplary embodiment, a push notification may be received by an out-of-band stack from a remote electronic device containing one or more commands to execute an operation on an electronic device, for example, to operate an actuator or connect to a message brokering server.

One exemplary embodiment includes a method and an apparatus that allows reducing network bandwidth consumption of an out-of-band system, where a communication tunnel may be established on demand using lesser overhead out-of-band signaling technologies. Some electronic devices may need to be accessed using a communication tunnel, such as, but not limited to using VPN, Intel® APF, SSL, TLS, etc., capable of encapsulating other communication protocols; such as accessing an electronic device using VNC, SNMP, WS-MAN, Telnet, Modbus/TCP, CAN (over TCP/IP), and other services/protocols. In one exemplary embodiment, such communication tunnel may be established on demand after receiving a push notification from a remote application. In one exemplary embodiment, an out-of-band stack receives a push notification from a remote push infrastructure, where such push notification includes an ID and a command to establish a communication tunnel. The out-of-band stack, having software capable of establishing such tunnel, may establish such tunnel, and in one exemplary embodiment, post to the appropriate queue of a remote message brokering server, a notification containing such push notification ID and data indicating of the status of the requested operation. In another exemplary embodiment, such push notification may originate from an in-band stack of the electronic device. In another exemplary embodiment, an out-of-band stack may communicate with a remote message brokering server, obtaining a notification from a queue, and if such notification contains a command for establishing an out-of-band tunnel, executing such command. In another exemplary embodiment, such notification may contain other attributes, such as conditions for establishing such tunnel, e.g., time, operating mode, presence or absence of a certain event, security configuration, etc.

One exemplary embodiment includes a method and an apparatus, where an electronic device is equipped with active management technology and/or manageability engine (ME), such as Intel® Active Management Technology (AMT) with out-of-band (OOB) communication capability. In one exemplary embodiment, such AMT/ME is capable of communicating using publish/subscribe communication model, and/or having multicasting, broadcasting, and/or pear to pear communication capabilities. In some exemplary embodiment, such AMT/ME may be capable of accessing a remote message brokering server and receiving and/or posting a message. In some exemplary embodiment, such AMT/ME may be communicatively and/or operably coupled with message brokering software located anywhere on the electronic device or elsewhere. In another exemplary embodiment, such AMT/ME may be able to broadcast and/or multicast notifications to plurality of websites and electronic devices. In another exemplary embodiment, such AMT/ME may be able to retransmit messages received from one or more websites and/or one or more electronic devices. In another exemplary embodiment, such AMT/ME may be able to receive push messages, for example, but not limited to Apple Push Notification Service, Android Cloud to Device Messaging Service, BlackBerry Push Service, Windows Push Notification Services, etc. In another exemplary embodiment, such messages may contain data instructing the AMT/ME to execute a code instruction or perform an operation; and in another exemplary embodiment, such operation may involve establishing a communication tunnel; and in another exemplary embodiment, such operation may involve altering operating mode of at least one processor. In another exemplary embodiment, such communication tunnel may be established between two or more electronic devices directly, peering such devices. In another exemplary embodiment, such AMT/ME may be able to post messages containing data related to events of the electronic device. In another exemplary embodiment, such messages may contain geo-location related data. In another exemplary embodiment, such messages may contain information related to in-band stack.

One exemplary embodiment of the disclosure includes circuitry being implemented as System on Chip (SoC), where among other components there is an in-band processor that executes instructions of an in-band operating system, and an out-of-band processor that executes instructions of an out-of-band operating system. The out-of-band operating system is capable of communicating, regardless of the underlain physical and logical media, using publish/subscribe, and/or pear to pear communication technologies.

One exemplary embodiment includes a system where there is an out-of-band stack, having and out-of-band controller communicatively coupled via an internal bus with an in-band circuitry. In one exemplary embodiment, such out-of-band controller may be coupled with an in-band controller in a way that allows accessing such in-band controller programming interfaces. In some exemplary embodiment, such interfaces may be debug interfaces. In some exemplary embodiment, the out-of-band stack may be communicatively coupled with a remote website in a way that via such website it is possible to access such interfaces of the in-band controller and exchange data. In another exemplary embodiment, an out-of-band stack may be able to access nonvolatile memory of the electronic device and read and/or write data to such memory. In another exemplary embodiment, such memory may be the memory where at least some part of the in-band stack is located.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. An apparatus comprising of:
at least one electronic device having at least one processor that operates the electronic device (in-band processor); and
a communications interface operably coupled with at least one in-band processor; and
at least one program of instructions or an operating system for operating the electronic device (in-band operating system), and
an independent program of instructions or an operating system (out-of-band operating system): and
wherein the out-of-band operating system is capable of sending and/or receiving data using at least one of: push technology other than SMS, and pull technology, which uses at least one logical communication method capable of at least one of: multiple recipients, multicast, broadcast addressing, pear to pear communication, publish/subscribe operating model.

2. An apparatus comprising of circuitry, having:
at least one processor coupled to at least one operating system (in-band operating system) to execute at least one in-band operating system; and
an in-band operating system-independent out-of-band operating system coupled to at least one processor; and
being able to perform at least one operation and/or execute at least one code instruction at a time when a status associated with at least one in-band operating system represents at least one of: missing, inaccessible, and inoperable; and
capable of sending and/or receiving data using at least one of: push technology other than SMS, and pull technology using at least one logical communication method capable of at least one of: multiple recipients, multicast, broadcast addressing, pear to pear communication,
publish/subscribe operating model.

3. Apparatuses according to claim 1 and claim 2, capable of sending and/or receiving at least one data packet over a network.

4. Apparatuses according to claim 1 and claim 2, wherein the out-of-band operating system, directly and/or indirectly, is capable of sending and/or receiving data to/from at least one in-band operating system, and/or at least one device communicatively and/or operably coupled with the electronic device.

5. Apparatuses according to claim 1 and claim 2, wherein an out-of-band operating system is capable of sending and/or receiving data using Short Message System (SMS).

6. Apparatuses according to claim 1 and claim 2, wherein an out-of-band operating system is capable of receiving data, and as a result executing at least one code instruction and/or performing at least one operation.

7. Apparatuses according to claim 1 and claim 2, wherein an out-of-band operating system is capable of performing at least one operation or executing at least one code instruction related to augmenting an operating mode of at least one processor that is coupled and/or operates an out-of-band operating system.

8. Apparatuses according to claim 1 and claim 2, wherein an out-of-band operating system is capable of establishing a communication tunnel via a network between an out-of-band operating system and at least one website and/or at least one electronic device.

9. Apparatuses according to claim 1 and claim 2, wherein out-of-band operating system is capable of performing at least one operation or executing at least one code instruction related to augmenting an operating mode of at least one processor that is coupled and/or operates an in-band operating system.

10. Apparatuses according to claim 1 and claim 2, having an out-of-band operating system and/or software executable by such out-of-band operating system provided from one or more of: a boot disc, a hidden partition in a hard disc drive, volatile and non-volatile data storage media operably and/or communicatively coupled with the electronic device, a protected memory that in-band operating system does not access, a protected partition, a BIOS partition, firmware services environment, a remote network location, a portable device.

11. Apparatuses according to claim 1 and claim 2, wherein the out-of-band operating system is coupled and/or executed with/by at least one processor (out-of-band processor) communicatively and/or operably coupled with the electronic device.

12. Apparatuses according to claim 1 and claim 2, wherein the out-of-band operating system is executed by at least one in-band processor.

13. Apparatuses according to claim 1 and claim 2, wherein the out-of-band operating system and at least one in-band operating system is executed concurrently or consecutively by at least one processor communicatively and/or operably coupled with the electronic device.

14. Apparatuses according to claim 1 and claim 2, wherein at least one in-band operating system operates in the virtualization environment where the host is the out-of-band operating system.

15. Apparatuses according to claim 1 and claim 2, wherein an out-of-band operating system is capable of writing and/or reading data into at least one of: volatile, nonvolatile, transitory, non-transitory memory, secure memory that is inaccessible by the in-band operating system, Trusted Platform Module (TPM) communicatively and/or operably coupled with the electronic device.

16. Apparatus according to claim 2, wherein at least one out-of-band processor being operably and/or communicatively coupled with at least one of: manageability engine (ME), BMC, IPMI, IPMB, SMB, AMT, or being a processor of the ME, and/or BMC, and/or AMT, or executing at least one code instruction of the ME, and/or BMC, and/or AMT.

17. A method and apparatus where at least one electronic device having:
active management technology, such as Intel® Active Management Technology (AMT); and/or manageability engine (ME); and
such AMT and/or ME is capable of sending and/or receiving data using at least one of: push technology other than SMS, and pull technology, which uses at least one logical communication method capable of at least one of:
multiple recipients, multicast, broadcast addressing, pear to pear communication, publish/subscribe operating model.

18. A method and apparatus according to claim 17 that is able to communicate over the Internet using an out-of-band (00B) channel.

19. A method and apparatus according to claim 17 that performs at least one operation or executes at least one code instruction related to establishing a network communication tunnel coupled with AMT and/or ME and at least one website and/or at least one electronic device.

20. A method and apparatus according to claim 17 that performs at least one operation or executes at least one code instruction related to augmenting an operating mode of at least one processor that is coupled and/or operates at least one of: AMT, ME, out-of-band operating system.

21. A method and apparatus according to claim 17 that performs at least one operation or executes at least one code instruction related to augmenting an operating mode of at least one processor that is coupled and/or operates at least one in-band operating system.

22. A method and apparatus according to claim 17 that is capable of sending and/or receiving data using Short Message System (SMS).

23. A tangible, machine-readable medium comprising a plurality of instructions that, in response to being executed, result in at least one out-of-band operating system and/or out-of-band processor of an electronic device receiving and/or sending data using at least one of: push technology other than SMS, and pull technology, which uses at least one logical communication method capable of at least one of: multiple recipients, multicast, broadcast addressing, pear to pear communication, publish/subscribe operating model; and executing at least one code instruction and/or operation.

24. According to claim 23, herein at least one out-of-band operating system and/or processor of an electronic device receiving and/or sending data over a network.

25. According to claim 23, herein such instruction and/or operation relates to establishing a communication tunnel via a network, between at least one electronic device having an out-of-band stack and at least one website and/or at least one electronic device.

26. According to claim 23, herein such instruction and/or operation relates to augmenting an operating mode of at least one out-of-band-processor.

27. According to claim 23, herein such instruction and/or operation relates to augmenting an operating mode of at least one in-band-processor.

28. According to claim 23, herein such instruction and/or operation relates to augmenting at least one of: configuration of an electronic device, software, and firmware of an electronic device.

29. According to claim 23, herein such instruction and/or operation relates to electronic device transmitting over a network at least one data packet.

30. According to claim 23, herein such instruction and/or operation relates to communicating directly and/or indirectly with at least one of: in-band operating system, device operably and/or communicatively coupled with the electronic device, and electronic memory operably and/or communicatively coupled with the electronic device.

31. According to claim 23, herein out-of-band operating system of an electronic device receiving and/or sending data using Short Message System (SMS).

32. A method comprising of:
at least one out-of-band operating system and/or processor of an electronic device receiving or sending data using at least one of: push technology other than SMS, and pull technology, which uses at least one logical communication method capable of at least one of: multiple recipient, multicast, broadcast addressing, pear to pear communication,
publish/subscribe operating model; and
executing at least one code instruction and/or operation.

33. A method according to claim 32, wherein there is a step providing that such at least one out-of-band operating system and/or processor of an electronic device receiving and/or sending data over a network.

34. A method according to claim 32, wherein there is a step of executing such at least one code of instruction and/or performing at least one operation related to establishing a network communication tunnel between at least one electronic device having an out-of-band stack and at least one website and/or at least one electronic device.

35. A method according to claim 32, wherein there is a step of executing such at least one code of instruction and/or performing at least one operation related to augmenting an operating mode of at least one out-of-band-processor.

36. A method according to claim 32, wherein there is a step of executing such at least one code of instruction and/or performing at least one operation related to augmenting at least one of: configuration of an electronic device, software, and firmware of an electronic device.

37. A method according to claim 32, wherein there is a step of executing such at least one code of instruction and/or performing at least one operation related to augmenting an operating mode of at least one in-band-processor.

38. A method according to claim 32, wherein there is a step of executing such at least one code of instruction and/or performing at least one operation related to electronic device transmitting over a network at least one data packet.

39. A method according to claim 32, wherein there is a step of executing such at least one code of instruction and/or performing at least one operation related to communicating directly and/or indirectly with at least one of: in-band operating system, device operably and/or communicatively coupled with the electronic device, and electronic memory operably and/or communicatively coupled with the electronic device.

40. A method according to claim 32, wherein there is a step of an out-of-band operating system of an electronic device receiving and/or sending data using Short Message System (SMS).

41. A system and a method comprising:
at least one electronic device having at least one network interface; and
at least one website that communicates via the Internet with at least one out-of-band operating system coupled with the electronic device, and is capable of accessing the Internet via said at least one network interface independently of the in-band operating system, and wherein the out-of-band operating system and in-band operating system are capable of exchanging data directly and/or indirectly.

42. A system and a method according to claim 41, wherein the out-of-band operating system communicates with at least one website using at least one of:
push technology and pull technology, which uses at least one logical communication method capable of at least one of: multiple recipients, multicast, broadcast addressing, pear to pear communication,
publish/subscribe operating model.

43. A system comprising of:
one or more processors (in-band processors);
a memory; and
one or more out-of-band controllers communicatively coupled to:
a network; and
one or more communications protocols for communicating with one or more remote websites over a network; and
one or more communication interfaces between one or more out-of-band controllers and one or more electronic device processors (in-band processors); and
wherein one or more out-of-band controllers provide an interface specifying one or more functions; and
capable of receiving data from a remote website via a network and performing at least one operation and/or executing at least one code instruction on an electronic device; and
wherein one or more out-of-band controllers communicate over a network with one or more websites using at least one of: push technology and pull technology, which uses at least one logical communication method capable of at least one of: multiple recipients, multicast, broadcast addressing, pear to pear communication, publish/subscribe operating model.

44. A system according to claim 43, wherein an execution engine is present on an electronic device capable of communicating with at least one out-of-band controller.

45. A system according to claim 43, wherein such operation can be at least one of: debugging, altering processor configuration, alerting processor operating mode, altering electronic device configuration, altering firmware and/or software, altering power state.
